(19) United States
(12) Patent Application Publication
(10) Pub. No.: US 2003/0014253 A1
(43) Pub. Date: Jan. 16, 2003

(54) APPLICATION OF SPEED READING TECHIQUES IN TEXT-TO-SPEECH GENERATION

(76) Inventor: CONAL P. WALSH, TORONTO (CA)

Correspondence Address: SMART AND BIGGAR, 438 UNIVERSITY AVENUE, SUITE 1500 BOX 111, TORONTO, ON, M5G2K8, CA

(21) Appl. No.: 09/448,508

(22) Filed: Nov. 24, 1999

(51) Int. Cl. G10L 13/08

(52) U.S. Cl. 704/260

(57) ABSTRACT

A method and device for converting text to speech such that playback duration is decreased while the comprehensibility of the generated speech is not significantly reduced is disclosed. A text segment initially undergoes linguistic profiling wherein a playing rate indicator for each word, and optionally each element of punctuation, is determined. The playing rate indicator is set to reflect the importance of the associated word or element of punctuation as ascertained through an application of speed-reading techniques, such as matching against a pre-selected word inventory, grammatical analysis, or punctuation analysis. As well, the playing rate indicator may reflect certain linguistic characteristics of the associated word, such as its length. The text is subsequently converted to speech by a text-to-speech engine capable of varying the playing speed of each word, and each pause associated with punctuation, in the text segment according to the corresponding playing rate indicator of the word or element of punctuation.

### FIELD OF THE INVENTION

The present invention relates to the conversion of text to speech, and more particularly to a method and device for converting text to speech such that playback duration is decreased without significantly reducing the comprehensibility of the message.

### BACKGROUND OF THE INVENTION

Text-to-speech (“TTS”) systems facilitate audible delivery of textual messages. TTS systems are useful in situations where accessing textual information may be inconvenient or impossible for the user. For example, TTS systems may be used to retrieve electronic mail (“e-mail”) remotely by telephone.

Generally, TTS systems operate by inputting fixed text segments, such as sentences, and converting them into speech through a specific algorithm. The particular algorithm employed determines the characteristics of the resultant audible speech. Less sophisticated TTS systems typically employ simpler conversion algorithms that may generate speech with a mechanical or unnatural sound. More advanced systems make use of complex prosody algorithms that generate speech which more closely models human speaking patterns in terms of intonation, tempo, rhythm and pitch.

Known TTS systems typically apply a predetermined speaking rate to all generated speech based on the designer's preference. This default rate may be perceived by the listener as being very slow, depending of course on such factors as the familiarity of the user with the synthetic voice, the quality of the transmission medium, and the complexity and predictability of the information being spoken. Excessive playing duration wastes valuable time and can result in frustration on the part of the listener.

To address the problem of slow playback, some TTS systems have added a user interface that permits the listener to increase the playing speed of the generated speech. In such systems, speech is typically accelerated through a uniform speedup of each synthesized word. Hence, important words are accelerated by the same factor as relatively insignificant words. This acceleration of key words tends to negatively impact on the user's ability to comprehend them. Disadvantageously, the diminished comprehensibility of the important words in turn tends to reduce the comprehensibility of the overall message.

Accordingly, what is needed is a method of converting text to speech such that the playback duration is decreased while the comprehensibility of the message is not significantly reduced.

### SUMMARY OF THE INVENTION

It is an object of the present invention to provide a method and device for converting text to speech such that playing duration is decreased without significantly reducing the comprehensibility of the generated speech.

Briefly, the foregoing and other objects are achieved through an application of speed-reading techniques to the TTS conversion process. The human skill of speed-reading involves the identification of words that do not contribute to comprehension and the accelerated scanning or skipping thereof. Similarly, the present invention evaluates words, and optionally punctuation, as to importance and certain other characteristics (e.g. word length) and processes them differently based on the identified “linguistic profile”. In particular, words of lesser importance are played at a faster rate or skipped entirely, while more meaningful words are played at a slower rate. Furthermore, longer words are played at a slightly faster rate than words of average length. In this manner, the comprehensibility of the most meaningful words in a message is maintained at a high level while the playback duration of the message is reduced.

In one aspect, there is provided a method of decreasing the playing duration of speech generated from a text segment comprising counting syllables in each word of said text segment and assigning a playing rate indicator to said each word of said text segment based on a total number of syllables in said word.

In another aspect, there is provided a method of decreasing the playing duration of speech generated from a text segment, comprising performing a grammatical analysis of said text segment and assigning a playing rate indicator to each word of said text segment based on said grammatical analysis.

In yet another aspect, there is provided a method of decreasing the playing duration of speech generated from a text segment comprising comparing each word of said text segment to an inventory of pre-selected words and assigning a playing rate indicator to said each word of said text segment based on said comparison.

A computing device and computer readable medium for carrying out the methods of the invention are also provided.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In figures which illustrate, by way of example, embodiments of the present invention,

FIG. 1 is a schematic diagram illustrating a text-to-speech system exemplary of an embodiment of the present invention;

FIG. 2 is a schematic diagram illustrating the linguistic profiling unit of FIG. 1 in greater detail;

FIG. 3 illustrates an exemplary playing rate indicator (“PRI”) array that may be used by the linguistic profiling unit of FIG. 2;

FIG. 4 is a schematic diagram illustrating the text-to-speech engine of FIG. 1 in greater detail;

FIGS. 5A, 5B and 5C are flowcharts illustrating a method exemplary of an embodiment of the present invention;

FIGS. 6A and 6B illustrate an exemplary instantiation of the PRI array of FIG. 3 prior to linguistic profiling and following linguistic profiling, respectively; and

FIGS. 7A and 7B are graphical representations of synthesized speech illustrating the acceleration in playing duration which may be effected.

### DETAILED DESCRIPTION

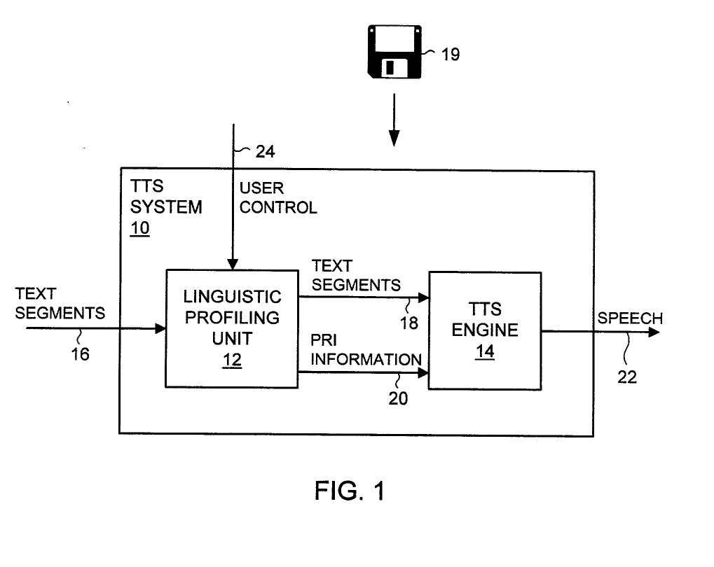

With reference to FIG. 1, a TTS system 10 includes a linguistic profiling unit 12 and a TTS engine 14. The TTS system 10 has two inputs, namely, a text segment input 16 and a user control information input 24. Inputs 16 and 24 input the subordinate linguistic profiling unit 12 of system 10. The TTS system 10 also has a single output 22 suitable for carrying synthesized speech from the TTS engine 14. The linguistic profiling unit 12 is interconnected with the TTS engine 14 by links 18 and 20. The first link 18 carries textual information while the second link 20 carries playing rate indicator (PRI) information. The TTS system 10 is typically a conventional computing device, such as an Intel x86 based or PowerPC-based computer, executing software in accordance with the method as described herein. The software may be loaded into the system 10 from any suitable computer readable medium, such as a magnetic disk 19, an optical storage disk, a memory chip, or a file downloaded from a remote source.

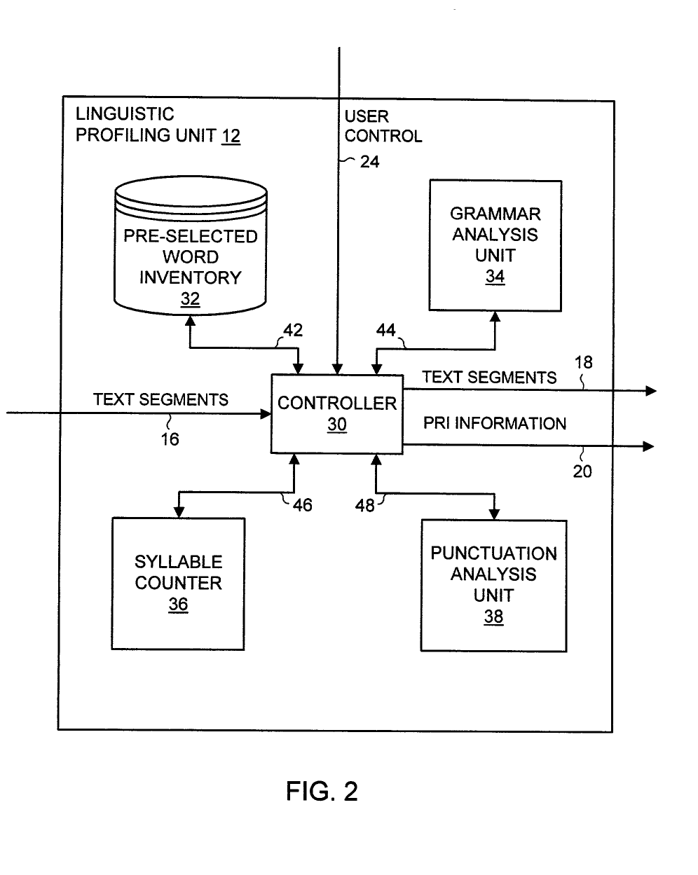

FIG. 2 illustrates an exemplary architecture of the linguistic profiling unit 12. The role of the linguistic profiling unit 12 is to determine the linguistic profile of each word and each element of punctuation in the input text segment. The linguistic profiling unit 12 includes a controller 30 and four linguistic profiling modules 32, 34, 36, and 38. Each module represents a different technique for identifying words or pauses that may be accelerated without significantly reducing the comprehensibility of the message. The four linguistic profiling modules in the present embodiment are a pre-selected word inventory 32; a grammar analysis unit 34; a syllable counter 36; and a punctuation analysis unit 38. These four modules are interconnected with the controller 30 by links 42, 44, 46 and 48, respectively.

The pre-selected word inventory 32 is a database of words that have previously been identified as being linguistically unimportant with respect to the particular application regardless of the context in which they are used. This database may contain prepositions or diminutive words, for example. Preferably, the pre-selected word inventory 32 may be easily configured to include or exclude words as needed to provide flexibility in adapting the invention to a particular application. The pre-selected word inventory 32 is capable of receiving words from the controller 30 and outputting match information to the controller 30 via link 42.

The grammar analysis unit 34 is a module capable of performing grammatical analysis on a text segment. Grammatical analysis typically comprises, at a minimum, the identification of the part of speech of each word in the segment, but may also include other forms of grammatical analysis. The grammar analysis unit 34 may employ a grammar analysis engine. Known grammar checking engines, such as Wintertree Software Inc.'s “Wgrammar” grammar checker, for example, may be adapted for this purpose. The grammar analysis unit 34 is capable of receiving text segments from the controller 30 and outputting grammatical information to the controller 30 via link 44.

The syllable counter 36 is a module capable of determining the number of syllables in a word. Syllable counting may be achieved for example through a breakdown of words into phonemes and a subsequent tallying thereof. The syllable counter 36 is capable of receiving words from the controller 30 and outputting syllable count information to the controller 30 via link 46.

The punctuation analysis unit 38 is a module capable of determining the importance of the punctuation that follows certain words in a text segment. Punctuation importance is typically dependent upon such factors as the importance of preceding or succeeding words, the type of punctuation, and the like. The punctuation analysis unit 38 is capable of receiving text segments from the controller 30 and outputting punctuation importance information to the controller 30 via link 48. Note that punctuation analysis is not a key aspect of this invention, therefore the punctuation analysis unit 38 may be omitted in some embodiments.

The controller 30 is responsible for overseeing the linguistic profiling process within the linguistic profiling unit 12. The controller 30 implements a number of alternative “linguistic profiling strategies” or operating modes which govern the method by which playing rate indicator (PRI) values associated with words and punctuation in a text segment are ascertained. The active strategy determines which of the modules 32, 34, 36, and 38 will be employed in the PRI assignment process, and how they will be employed.

Strategies are user-selectable via input 24 to the controller 30.

Table I below provides a representation of two exemplary linguistic profiling strategies that may be implemented by the controller 30. The first strategy, Strategy A, is relatively simple, requiring only that the words of the text segment be compared against 30 entries in the pre-selected word inventory 32. That is, according to Strategy A, a controller 30 processing a text segment will only increment the PRI of a word (i.e. change the PRI value to indicate a faster playing rate for the word) if the word matches an entry in the pre-selected word inventory 32. The second strategy, Strategy B, is more complex. Strategy B employs each of the four modules 32, 34, 36 and 38 in the linguistic profiling process. As indicated in Table I, a controller 30 processing a text segment in accordance with Strategy B will increment a word's PRI either when the word matches an entry in the pre-selected word inventory 32, or when the word is identified to be a preposition by the grammar analysis unit 34. Furthermore, if the word is determined to have four or more syllables by the syllable counter 36, the word's PRI will be set to a “long” value regardless of its previous PRI. This aspect of Strategy B distinguishes long words, which will be accelerated only slightly in accordance with typical human speaking patterns, from standard words, which may be accelerated to a greater degree. In addition, according to Strategy B, a controller 30 will increment the PRI of each element of punctuation identified as a comma (in order to shorten the pause associated with commas) and decrement that of each element of punctuation identified as a period (to effect a greater pause duration at the end of sentences).

TABLE I
Linguistic Profiling Strategies

| Linguistic | | | | |
|---|---|---|---|---|
| Profiling | Pre-selected Word | Grammar | Syllable | Punctuation |
| Strategy | Matching? | Analysis? | Counting? | Analysis? |
| Strategy A | ON: increment PRI | OFF | OFF | OFF |
| | of matched words | | | |
| Strategy B | ON: | ON: | ON: flag words | ON: increment PRI |
| | increment PRI of | increment | having 4 + | associated with |
| | matched words | PRI of | syllables as | commas; decrement |
| | | prepositions | “long” | PRI associated with |
| | | | | periods. |

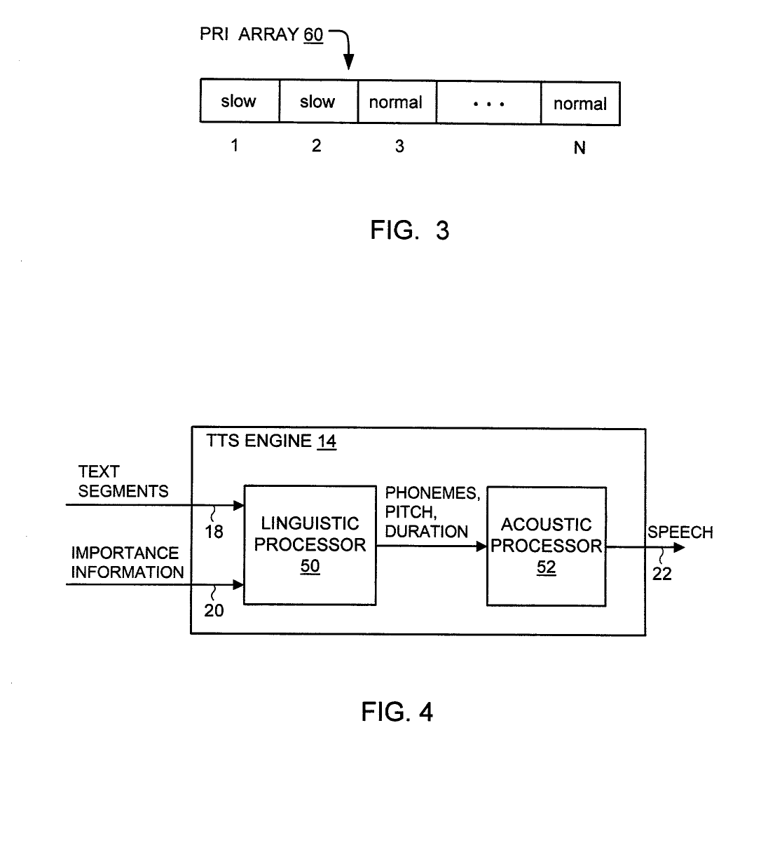

The controller 30 develops a PRI data array for each text segment being processed within linguistic profiling unit 12. An exemplary PRI array 60 is illustrated in FIG. 3. Each element of the array 60 represents a word or element of punctuation in the text segment, and contains an enumerated value representing the PRI of the corresponding word or element of punctuation. In the present embodiment, there are three enumerated PRI values for words and punctuation: “slow”, “normal”, and “fast”. An additional value of “long” is used in association with long words (i.e. words having a high syllable count).

An exemplary architecture of the TTS engine 14 is shown in FIG. 4. The TTS engine 14 is responsible for converting input text segments and PR′ information into audible speech. It should be appreciated that many aspects of this structure are well known to those skilled in the art and are described, for example, in U.S. Pat. No. 5,774,854, the contents of which are incorporated by reference herein.

The TTS engine 14 contains a linguistic processor 50 and an acoustic processor 52 that are interconnected. The linguistic processor 50 is capable of converting input text and PRI information into a series of phonemes, pitch and duration values. The linguistic processor 50 includes a duration assignment unit (not shown) which allows the duration of words and pauses associated with punctuation to be adjusted in accordance with their associated PRI. The linguistic processor 50 may additionally include such sub-components as a text tokenizer; a word expansion unit; a syllabification unit; a phonetic transcription unit; a part of speech assignment unit; a phrase identification unit; and a breath group assembly unit, depending upon the complexity of the employed text-to-speech algorithm.

The acoustic processor 52 is a module capable of converting a received sequence of phonemes, pitch and duration values into sounds comprising audible speech. The acoustic processor 52 typically includes such sub-components as a diphone identification unit; a diphone concatenation unit; a pitch modifier; and an acoustic transmission unit.

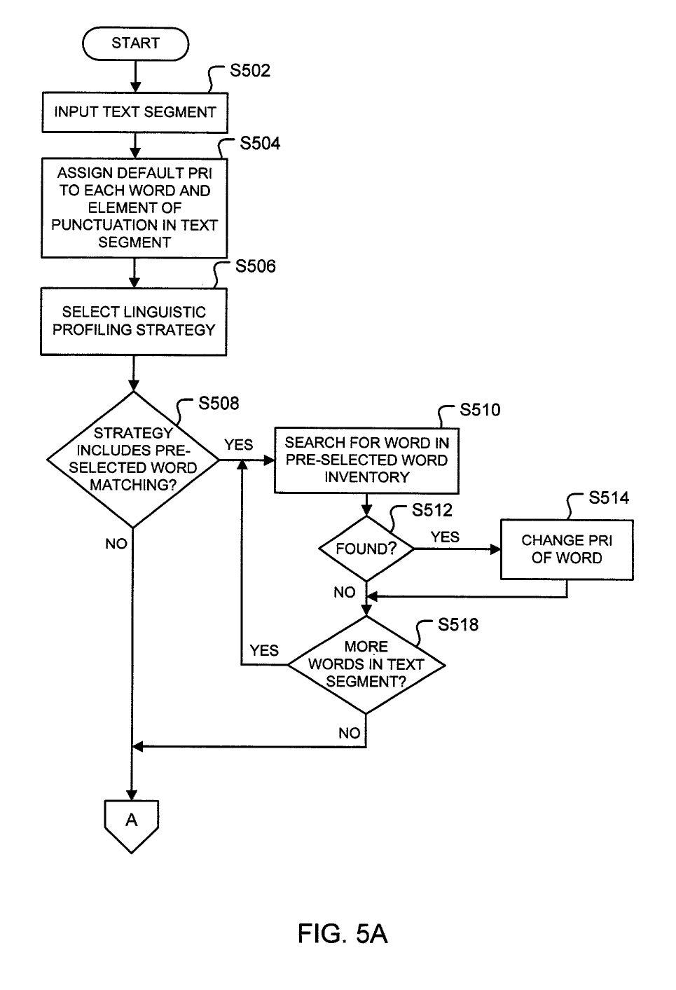

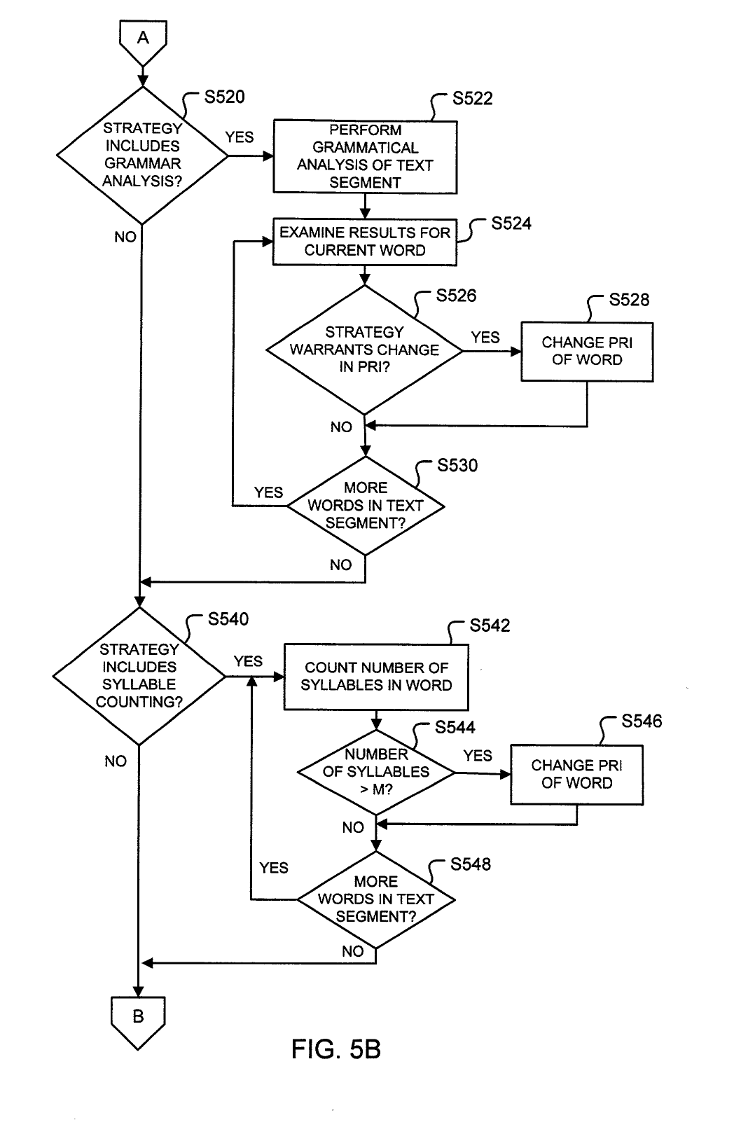

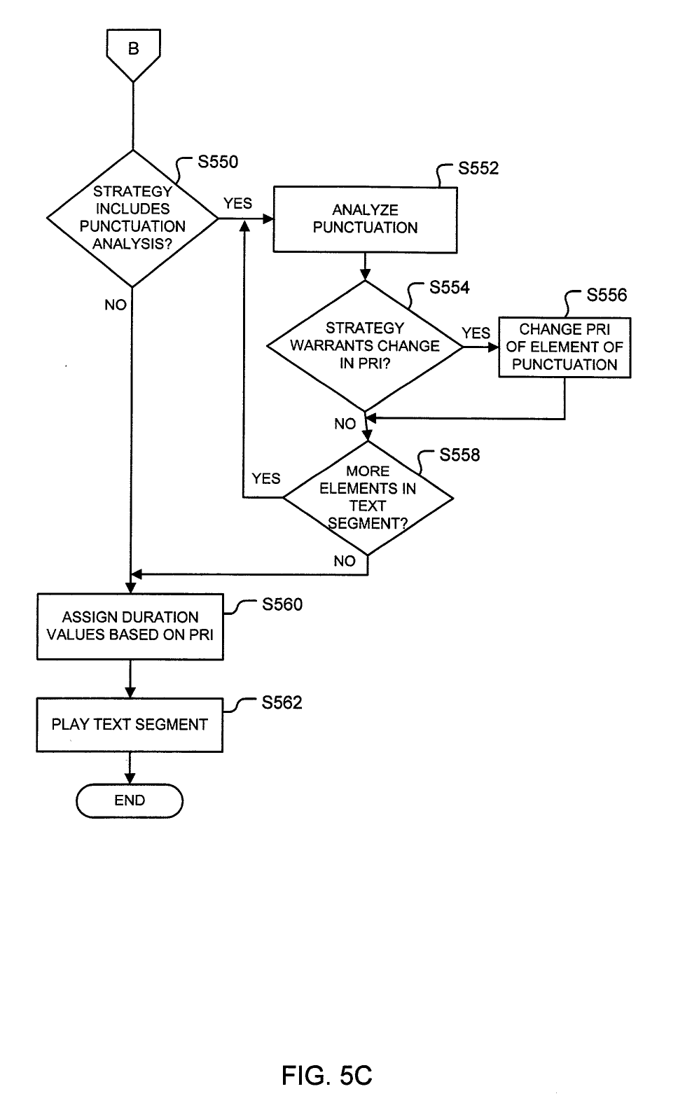

The operation of the present embodiment is illustrated in FIGS. 5A, 5B and 5C, with additional reference to FIGS. 1, 2, 6A, 6B, 7A and 7B. It is worth noting that the text-to-speech conversion process is broken into two phases. The first phase is the linguistic profiling phase, during which input text segment and user control data are converted into text and PRI information. This phase spans steps S502 to S558 in FIGS. 5A to 5C and takes place within the linguistic profiling unit 12. The second phase is the speech generation phase, during which the text and PRI information are converted into audible speech. The second phase spans steps S560 to S562 in FIG. 5C and takes place within the TTS engine 30 14.

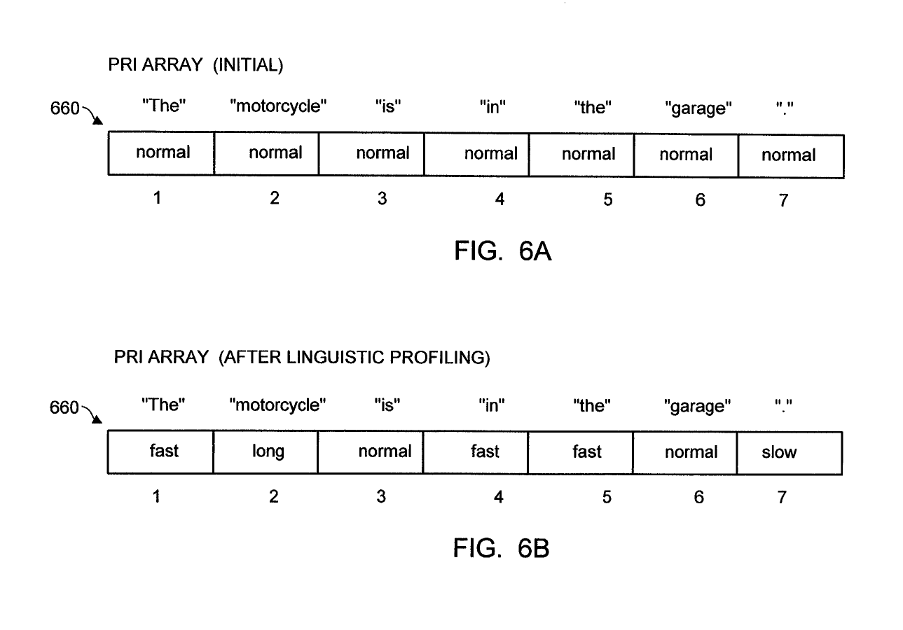

In the first phase, a text segment is input to the TTS system 10 and is received by the controller 30 in step S502 (FIG. 5A). In the present example, the received data consists of the text segment “The motorcycle is in the garage.” In response to this input, the controller 30 initializes a PRI array 660 corresponding to the text segment (FIG. 6A). This step typically requires the input text segment to be processed into tokens, or units roughly corresponding to words and punctuation but possibly including other linguistic constructs such as abbreviations, numbers or compound words. In the present example, seven tokens (six words and one element of punctuation) are identified. Accordingly, the array 660 has seven elements. The first six elements of the array correspond to the six words in the text segment, while the seventh element corresponds to the punctuation (a period) after the sixth word in the text segment. A default PRI value of “normal” is assigned by the controller 30 to each word and element of punctuation (S504), such that the initial state of the array is as shown in FIG. 6A.

Next, in step S506 the controller 30 reads the user control input 24 in order to determine which of the two alternative linguistic profiling strategies, Strategy A or Strategy B, should be employed in the text-to-speech conversion process. In the present example, it is assumed that the user has selected Strategy B, as described in Table I above, as the active strategy.

The subsequent steps of the linguistic profiling phase involve the controller 30 interacting with the various linguistic profiling modules 32, 34, 36, and 38, in accordance with the active strategy, in order to effect changes to the PRI array 660 that reflect the ascertained importance and linguistic characteristics of the associated words and punctuation in the text segment.

In step S508, the controller 30 examines the active strategy (Strategy B) to determine whether or not pre-selected word matching is required. Because Strategy B in the present example does in fact include pre-selected word matching, the controller 30 proceeds to interact with the pre-selected word inventory 32 via link 42 (FIG. 2) in order to determine whether any of the words in the text segment are contained therein. In the present example, it is assumed that the pre-selected word inventory 32 has been previously configured to include entries for the words “A”, “AND”, and “THE”. Interaction between the controller 30 and the pre-selected word inventory 32 in steps S10-S518 reveals that the first word “The” and fifth word “the” of the text segment match an entry “THE” in the inventory.

Accordingly, controller 30 increments the enumerated PRI value of the first and fifth elements in array 660 (FIG. 6B) from their default value of “normal” to “fast” (S514), thereby reflecting the reduced importance of the first and fifth word of the text segment.

Next, in step S520 (FIG. 5B), the controller 30 examines the active strategy to determine whether or not grammatical analysis is required. Because Strategy B in the present example does in fact include grammatical analysis, in step S522 the controller 30 proceeds to pass the text segment to the module 34 via link 44 (FIG. 2) for grammatical analysis. The grammar analysis unit 34 performs grammatical analysis in accordance with the active strategy, which dictates that the analysis is to consist of the identification of the part of speech of each word in the text segment. Upon the completion of the analysis, the unit 34 communicates the results to the controller 30 via link 44. The controller 30 examines the results of the analysis for each word (S524-S530) in accordance with the active strategy, which further dictates that only prepositions are to have their PRI value incremented. The examination reveals that the word “in” in the fourth ordinal position of the input text segment has been identified as a preposition. Accordingly, the controller 30 increments the associated PRI value in the fourth element of array 660 (FIG. 6B) from “normal” to “fast” in step S528, thereby reflecting the reduced importance of this word.

Next, in step S540, the controller 30 examines the active strategy to determine whether or syllable counting is required. This examination reveals that syllable counting is in fact necessary, and moreover, in accordance with Strategy B, that words having four or more syllables are to be flagged as “long” words. Accordingly, the controller 30 proceeds to interact with the syllable counter 36 in steps S542-S548 in order to determine the syllable count of each word in the text segment. This interaction reveals that the second word in the text segment, “motorcycle”, does in fact have four syllables and should therefore be flagged as a “long” word. Thus, the controller 30 changes the enumerated value associated with the word “motorcycle”, that is, the value in the second ordinal position of array 660 (FIG. 6B), from “normal” to “long” in step S546.

Subsequently, in step S550 (FIG. 5C), the controller 30 examines the active strategy to determine whether or not punctuation analysis is required. This examination reveals that punctuation analysis is in fact necessary, and moreover, that in accordance with Strategy B, commas are to have their PRI incremented, and periods are to have their PRI decremented. As a result, the controller 30 proceeds to interact with the punctuation analysis unit 38 in step S552-S558 to determine whether pause adjustment is required for any of the punctuation in the text segment. This interaction reveals that the period following the last word in the text segment (“garage”) should have its PRI decremented. Accordingly, the controller 30 decrements the enumerated PRI value associated with the final pause, that is, the value in the seventh ordinal position of the array 660 (FIG. 6B), from “normal” to “slow” in step S556.

Hence, at the completion of phase 1, the contents of the PRI array 660 are as shown in FIG. 6B. At this stage the PRI array as well as the input text segment are communicated from the linguistic profiling unit 12 to the TTS engine 14.

Turning to phase 2, and with additional reference to FIG. 4, the linguistic processor 50 of TTS engine 14 receives the text segment and PRI information via links 18 and 20, respectively, and proceeds to convert the input text segments to a sequence of phonemes, pitch and duration values. Duration is assigned to words and punctuation by the duration assignment unit of the linguistic processor 50 in accordance with the associated PRIs in array 660. Specifically, the duration of each word and each element of punctuation may be assigned as indicated in Table II below.

TABLE II
Duration Assignment
WORDS AND PUNCTUATION

| PRI | Assigned Duration |
|---|---|
| Fast | Default duration × 0.5 |
| Normal | Default duration |
| Slow | Default duration × 1.5 |
| Long | Default duration × 0.75 |

Aside from duration assignment, various other steps may be performed by the linguistic processor 50, including text tokenization; word expansion; syllabification; phonetic transcription; part of speech assignment; phrase identification; and breath group assembly, as have been described in the prior art. The exact scope of the processing performed by the linguistic processor 50 is dependent upon the complexity of the adopted TTS conversion algorithm. The resulting series of phonemes, pitch and duration values are then passed to the acoustic processor 52.

The acoustic processor 52 converts the received series of phonemes, pitch and duration values into audible speech. As described in the prior art, this conversion typically involves the steps of diphone identification, diphone concatenation, pitch modification and acoustic transmission, however, it may alternatively consist of other steps, depending upon the employed TTS algorithm. Generated speech is provided to the output 22 of the overall TTS system 10.

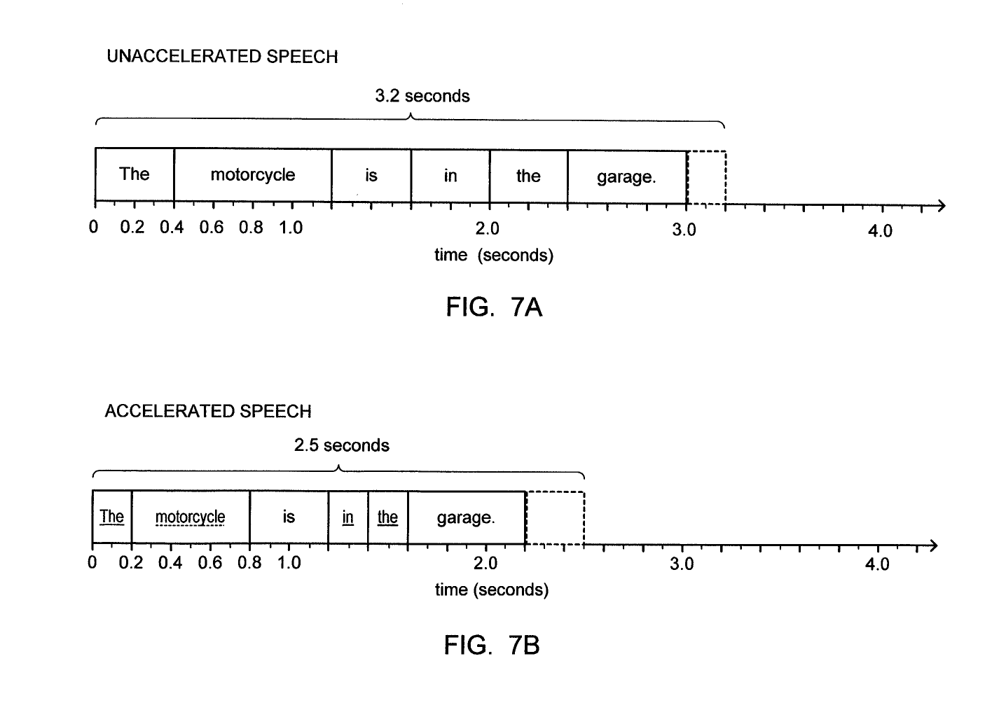

A graphical representation of the decrease in playing duration effected by the present embodiment is provided in FIGS. 7A and 7B. FIG. 7A represents the playing of the exemplary text segment “The motorcycle is in the garage.” as audible speech at the default rate, without any acceleration. That is, FIG. 7A corresponds with an array 660 having a PRI of “normal” in each of its elements (i.e. similar to FIG. 6A) at the conclusion of the linguistic profiling phase. FIG. 7B, on the other hand, represents the playing of the same text segment after it has been accelerated in accordance with Strategy B and the acceleration factors of Table II. In other words, FIG. 7B corresponds with a PRI array 660 having the values illustrated in FIG. 6B at the conclusion of the linguistic profiling phase. Note that solid borders within FIGS. 7A and 7B indicate audible words while dashed borders indicate pauses. Each unit on the horizontal axis represents a fixed unit of time of 0.1 seconds.

In FIG. 7A, it can be seen that default playing duration for the exemplary text segment, without acceleration, is 3.2 seconds. After being processed by the preferred embodiment as described above, however, the playing duration is reduced to 2.5 seconds, as illustrated in FIG. 7B. Note that only the underlined words have been accelerated, with a dotted underline indicating a lesser degree of acceleration associated with a long word.

Advantageously, the playing duration has been reduced by 0.7 seconds or approximately 22%, yet the comprehensibility of the message has not been significantly reduced since such key words as “garage” have been maintained at their default rate, or have been accelerated only slightly (e.g. “motorcycle”) in accordance with the active Strategy B.

The potential modifications to the above-described embodiment are many. Significantly, the TTS system 10 may be implemented on multiple computing devices rather than just one. For example, the linguistic profiling unit 12 may be implemented on a first computing device and the TTS engine 14 may be implemented on a second computing device.

As well, a person skilled in the art will recognize that the linguistic profiling unit 12 may have various alternative organizations. The number of linguistic profiling modules may be greater than or less than four, depending upon the number and type of techniques employed to accelerate speech within the application. In cases where the number of linguistic profiling modules is greater than four, techniques other than the ones described may be employed to determine the importance of words or pauses in the text segment.

Also, the allotment of processing as between the controller 30 and the various linguistic profiling modules may be different than described. For example, the linguistic profiling modules may be responsible for making changes to the PRI array 60 directly instead of the controller 30. Fundamentally, the controller 30 and the various linguistic profiling modules may not in fact be distinct. Instead, controlling activities and linguistic profiling activities may be merged within the linguistic profiling unit 12.

The number and scope of linguistic profiling strategies may also differ. For example, in some embodiments, the invention may employ only a single, fixed strategy for linguistic profiling that is tailored to the particular application. Alternatively, in cases where multiple strategies exist, the active strategy may be automatically selected by the TTS system 10 based on the characteristics of the input data, rather than being user-selectable. Furthermore, the scope of linguistic profiling strategies may be broader or narrower than the scope of the strategies described in Table I, in terms of the manner in which the array 60 is manipulated. For instance, a different strategy could require, among other things, that words with three or more syllables (rather than four or more) be flagged as “long” words. Some strategies may involve the wholesale skipping of certain words of lesser importance to promote greater acceleration of playing speed. Alternatively, other strategies may prohibit the skipping or even the acceleration of certain parts of speech that are typically central to the comprehensibility of the message, such as nouns.

Various approaches may also be taken towards the structure and maintenance of PRI information associated with a given text segment. For example, PRI information may be 10 represented by means of an alternative data structure, such as a linked list, rather than as an array. Moreover, the range of potential PRI values for a word or element of punctuation may be greater than or less than the four enumerated values of the present embodiment, to support greater or lesser granularity in the available degrees of speedup (respectively). PRI values may also be expressed numerically. Conveniently, numerical values that match corresponding acceleration or deceleration factors in the duration assignment unit may be employed. Finally, PRI information may be merged with textual data rather than being separately maintained. In that case, one link may be sufficient to communicate text and PRI information between the linguistic profiling unit 12 and the TTS engine 14.

It is also worth noting that the acceleration and/or deceleration factors applied by the duration assignment unit may be different than the exemplary factors of 0.5, 0.75 and 1.5 shown in Table II. Ideally, these factors are easily modifiable to support greater flexibility in adapting the present invention to a particular application.

Lastly, a person skilled in the art will recognize that significant gains in efficiency, both in terms of the effort required to implement the invention and in run-time processing, may be realized through the elimination of redundancies in the described embodiment, especially as between the linguistic profiling unit 12 and the TTS engine 14. For example, a common phoneme generator may be employed both for the purposes of syllable counting within the linguistic profiling unit 12 and speech generation within the TTS engine 14. As another example, tokens may be passed from the linguistic profiling unit 12 to the TTS engine 14 instead of raw text to avoid possible duplication in tokenization processing in the latter stage.

The foregoing is merely illustrative of the principles of the invention. Those skilled in the art will be able to devise numerous arrangements which, although not explicitly shown or described herein, nevertheless embody those principles that are within the spirit and scope of the invention, as defined by the claims.

What is claimed is:

1. A method of decreasing the playing duration of speech generated from a text segment, comprising:
(a) counting syllables in each word of said text segment; and
(b) assigning a playing rate indicator to said each word of said text segment based on a total number of syllables in said word.

2. The method of claim 1, further comprising generating speech from said text segment such that a playing rate of a generated word is according to said playing rate indicator.

3. The method of claim 2, wherein said playing rate of a given generated word is increased where the playing rate indicator of said word is indicative of a higher number of syllables and slowed where the playing rate indicator of said word is indicative of a lower number of syllables.

4. The method of claim 3, further comprising decreasing the duration of pauses associated with selected punctuation in said text segment.

5. The method of claim 1, wherein said playing rate indicator of said each word is changed when a syllable count of said each word increases above a threshold number of syllables.

6. A method of decreasing the playing duration of speech generated from a text segment, comprising:
(a) performing a grammatical analysis of said text segment; and
(b) assigning a playing rate indicator to each word of said text segment based on said grammatical analysis.

7. The method of claim 6, further comprising generating speech from said text segment such that a playing rate of a generated word is according to said playing rate indicator.

8. The method of claim 7, further comprising decreasing the duration of pauses associated with selected punctuation in said text segment.

9. The method of claim 8, wherein said grammatical analysis comprises the identification of a part of speech of the words in the text segment.

10. The method of claim 9, wherein said playing rate indicator of said each word is set to reflect a slow playing rate for certain parts of speech and a fast playing rate for other parts of speech.

11. The method of claim 10, wherein said certain parts of speech comprise nouns.

12. The method of claim 11, wherein a word with a playing rate indicator indicative of a slow playing rate is omitted from the generated speech.

13. A method of decreasing the playing duration of speech generated from a text segment, comprising:
(a) comparing each word of said text segment to an inventory of pre-selected words; and
(b) assigning a playing rate indicator to said each word of said text segment based on said comparison.

14. The method of claim 13, further comprising generating speech from said text segment such that a playing rate of a generated word is according to said playing rate indicator.

15. The method of claim 14, further comprising decreasing the duration of pauses associated with selected punctuation in said text segment.

16. The method of claim 15, wherein said playing rate indicator of each word is set to reflect a slow playing rate when said each word matches an entry in said inventory.

17. The method of claim 16, further comprising omitting from the generated speech a word with a playing rate indicator indicative of a slow playing rate.

18. A computing device comprising:
(a) a processor;
(b) persistent storage memory in communication with said processor, storing processor readable instructions adapting said device to:
(i) receive a text segment;
(ii) count syllables in each word of said text segment; and
(iii) assign a playing rate indicator to said each word of said text segment based on a total number of syllables in said word.

19. The computing device of claim 17, wherein said processor readable instructions further adapt said device to:
(iv) generate speech from said text segment such that a playing rate of a generated word is according to said playing rate indicator.

20. A computing device comprising:
(a) a processor;
(b) persistent storage memory in communication with said processor, storing processor readable instructions adapting said device to:
(i) receive a text segment;
(ii) perform a grammatical analysis of said text segment; and
(iii) assign a playing rate indicator to each word of said text segment based on said grammatical analysis.

21. The computing device of claim 19, wherein said processor readable instructions further adapt said device to:
(iv) generate speech from said text segment such that a playing rate of a generated word is according to said playing rate indicator.

22. A computing device comprising:
(a) a processor;
(b) persistent storage memory in communication with said processor, storing processor readable instructions adapting said device to:
(i) receive a text segment;
(ii) compare each word of said text segment to an inventory of pre-selected words; and
(iii) assign a playing rate indicator to said each word of said text segment based on the results of said comparison.

23. The computing device of claim 21, wherein said processor readable instructions further adapt said device to:
(iv) generate speech from said text segment such that a playing rate of a generated word is according to said playing rate indicator.

24. A computer readable medium storing computer software that, when loaded into a computing device, adapts said device to:
(a) receive a text segment;
(b) count syllables in each word of said text segment; and
(c) assign a playing rate indicator to said each word of said text segment based on a total number of syllables in said word.

25. The computer readable medium of claim 23, wherein said computer software further adapts said device to:
(d) generate speech from said text segment such that a playing rate of a generated word is according to said playing rate indicator.

26. A computer readable medium storing computer software that, when loaded into a computing device, adapts said device to:
(a) receive a text segment;
(b) perform a grammatical analysis of said text segment; and
(c) assign a playing rate indicator to each word of said text segment based on said grammatical analysis.

27. The computer readable medium of claim 25, wherein said computer software further adapts said device to:
(d) generate speech from said text segment such that a playing rate of a generated word is according to said playing rate indicator.

28. A computer readable medium storing computer software that, when loaded into a computing device, adapts said device to:
(a) receive a text segment;
(b) compare each word of said text segment to an inventory of pre-selected words; and
(c) assign a playing rate indicator to said each word of said text segment based on the results of said comparison.

29. The computer readable medium of claim 27, wherein said computer software further adapts said device to:
(d) generate speech from said text segment such that a playing rate of a generated word is according to said playing rate indicator.
